(19) United States
(12) Patent Application Publication
(10) Pub. No.: US 2022/0251486 A1
(43) Pub. Date: Aug. 11, 2022

(54) A METHOD FOR DRAINING FERMENTING MUST FROM A TANK, AND RELATED SYSTEMS

(71) Applicant: Pulsair Systems, Inc., Bellevue, WA (US)

(72) Inventor: John R. Parks, Bellevue, WA (US)

(21) Appl. No.: 17/605,511

(22) PCT Filed: Apr. 22, 2019
(86) PCT No.: PCT/US19/28578

§ 371 Date: Oct. 21, 2021

(51) Int. Cl. C12G 1/032; B01F 33/40; B01F 35/221; B01F 33/81

(52) U.S. Cl. CPC C12G 1/0216; B01F 33/405; B01F 2101/16; B01F 35/2213; B01F 33/813; B01F 33/408

(57) ABSTRACT

A method for draining fermenting must from a fermentation tank comprises: a) breaking into chunks a cap that forms in the tank while must ferments in the tank, b) after breaking the cap, mixing the must to homogenize the must and reduce the size of the cap chunks to a size that can pass through a drain of the tank, and c) opening the drain in the fermentation tank to remove the must from the tank. Breaking the cap into chunks includes: a) injecting gas into the must to form a bubble in the must, b) moving the bubble through the must to generate a flow of must within the fermentation tank, and c) shearing a surface of the cap with the generated flow to break the cap into chunks Mixing the must to reduce the size of the cap chunks includes: a) injecting gas into the must to form a bubble in the must, and b) moving the bubble through the must to mix the must.

### BACKGROUND

Vinification is a process of making wine by fermenting the juice of a fruit, for example grapes, with other ingredients. The vinification process for making wine from grapes typically includes crushing grapes to separate the grape's juice from the other components of the grapes, for example the skins and pulp, and then fermenting the grape juice with the grape's other components in a tank. Collectively, the grape juice, skins, pulp and/or other components fermenting in a tank is called must. As the must ferments, the skins, pulp and/or other components coalesce to form a cap on top of the fermenting juice. To extract phenolic compounds, such as tannins that give a wine body and complexity, and soften an aged wine, from the skin and otherwise assist the fermentation of the juice, the cap is broken into chunks, and may or may not be aggressively mixed with the fermenting juice. Often the cap is periodically broken into chunks while the must ferments, and at the end of fermentation the cap is almost always broken into chunks and separated from the juice. Then, depending on the winemaker's preference, the separated cap chunks may be pressed to extract even more of the phenolic compounds.

A common method for breaking the cap includes inserting a paddle into the tank and mixing the contents of the tank. To perform this method, one typically opens the tank at the desired time and strikes the cap with the paddle to break the cap into portions. If the vinification process requires aggressively mixing the cap portions with the fermenting juice, then one stirs fermenting juice and cap portions to disperse the cap portions throughout the juice. At the end of the fermentation process when much of the juice has been removed from tank, one typically jumps into the tank to break the remaining cap into chunks for easier removal from the tank and possible pressing to extract more of the phenolic compounds.

Unfortunately, this method is not the most efficient method for breaking the cap and/or obtaining the cap for a final pressing. Breaking the cap with a handheld paddle requires one to provide the power to overcome the bond attaching the grape skins and other components to each other. And jumping into the tank after fermentation is complete, and manually breaking the cap can be dangerous for the person in the tank, and expose the tank and the cap chunks to unwanted microorganisms.

Thus, there is a need for a system that can efficiently break the cap that develops as must ferments and allow the wine maker to easily extract the cap from the tank to be pressed if desired.

### SUMMARY

In one aspect of the invention, a method for draining fermenting must from a fermentation tank comprises: a) breaking into chunks a cap that forms in the tank while must ferments in the tank, b) after breaking the cap, mixing the must to homogenize the must and reduce the size of the cap chunks to a size that can pass through a drain of the tank, and c) opening the drain in the fermentation tank to remove the must from the tank. Breaking the cap into chunks includes: a) injecting gas into the must to form a bubble in the must, b) moving the bubble through the must to generate a flow of must within the fermentation tank, and c) shearing a surface of the cap with the generated flow to break the cap into chunks. Mixing the must to reduce the size of the cap chunks includes: a) injecting gas into the must to form a bubble in the must, and b) moving the bubble through the must to mix the must.

Because gravity causes the bubble to rise through the must one does not have to generate power to move the bubble through the must. The power one needs to generate is the power required to inject gas into the must in the fermentation tank. Thus, the process consumes less power than conventional mixing and cap breaking techniques, which makes the process more efficient than conventional techniques. And by mixing the must after breaking the cap one can reduce the size of the cap chunks to a size that will pass through the fermentation tank's drain and allow one to easily drain the tank and collect the cap chunks for subsequent pressing, if desired. Thus, one does not have to get into the tank 14 to get all or the remaining portion of the cap out of the tank 14.

In another aspect of the invention, a system for draining fermenting must from a fermentation tank comprises a drain operable to allow fermenting must to flow out of the tank, an injector operable to inject gas into the fermenting must held in the tank to form a bubble operable to break a cap formed in the must, and to mix the must, and a source of gas to supply the injector. The system also comprises a controller operable to open and close the injector according to a draining protocol. The controller includes a memory operable to store the draining protocol that includes instructions for opening and closing the injector during a break-cap period and during a mix period that follows the break-cap period. The controller also includes a processor operable to retrieve the draining protocol from the memory, and open and close the injector according to the draining protocol's instructions.

### BRIEF DESCRIPTION OF THE DRAWINGS

FIG. 1 shows a system for draining fermenting must from a tank, according to an embodiment of the invention.

Each of FIGS. 2A and 2B shows bubbles generated by the system shown in FIG. 1 moving through must in a tank to break a cap formed in the must, each according to an embodiment of the invention.

FIG. 3 shows a schematic diagram of an operation of the system shown in FIG. 1 to generate a series of bubbles by following a draining protocol, according to an embodiment of the invention.

FIG. 4 shows a schematic diagram of a controller that the system shown in FIG. 1 incorporates, according to an embodiment of the invention.

FIG. 5 shows a perspective view of a system for draining fermenting must from a tank, according to another embodiment of the invention.

FIG. 6 shows a perspective view of another system for draining fermenting must from a group of tanks, according to yet another embodiment of the invention.

### DETAILED DESCRIPTION

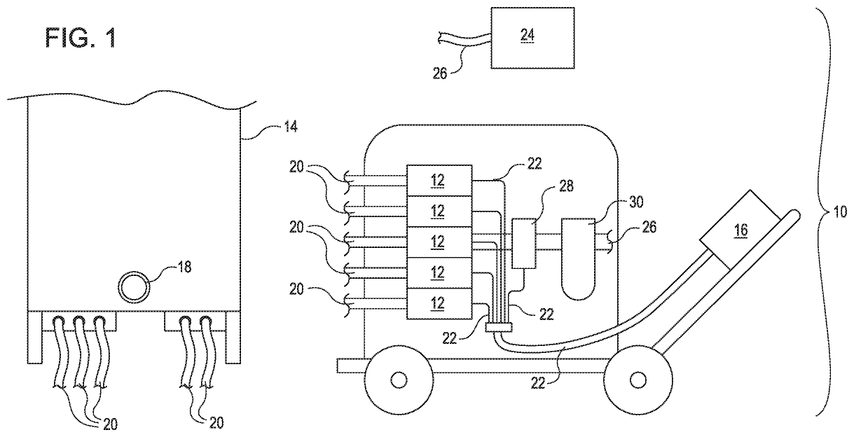

FIG. 1 shows a system 10 for draining fermenting must from a tank, according to an embodiment of the invention. The system 10 includes an injector 12 to inject gas (not shown) into the must (not shown in FIG. 1 but shown in FIGS. 2A and 2B) that is fermenting in the tank 14, and a controller 16 to open and close the injector 12. The tank 14 includes a drain 18 through which the must passes when being removed from the tank 14. When the controller 16 opens the injector 12, gas flows through the injector 12, then through a conduit 20 that couples the injector 12 with the tank 14, then into the tank 14. As discussed in greater detail in conjunction with the FIGS. 2A and 2B, when the gas is released into the must, the gas forms a bubble that rises up through the must. As the bubble rises through the must, the bubble's movement generates a flow of must within the tank 14 that can break a cap (shown in FIG. 2A) of skins, pulp and other components that has formed during fermentation into smaller portions or chunks. When the bubble reaches the cap, the bubble may pierce through the cap or cause the cap to tip into the fermenting juice of the must, to also break the cap. After the cap is broken, the controller 16 opens the injector 12 again to inject gas into the must, again. Another bubble forms in the must and rises through it to mix the must in order to homogenize the must and reduce the size of the cap chunks to a size that can pass through the tank's drain 18.

Because gravity causes the bubble to rise through the must one does not have to generate power to move the bubble through the must. The power one needs to generate is the power required to inject the gas into the must in the tank 14. Thus, the process consumes less power than conventional mixing and cap breaking techniques, which makes the process more efficient than conventional techniques. And by mixing the must after breaking the cap one can reduce the size of the cap chunks to a size that will pass through the fermentation tank's drain and allow one to easily drain the tank and collect the cap chunks for subsequent pressing, if desired. Thus, one does not have to get into the tank 14 to get all or the remaining portion of the cap out of the tank 14.

Still referring to FIG. 1, the must that ferments in the tank 14 is developed from grapes to make wine. In other embodiments, the must may be developed from other fruit, such as apples and peaches, and/or from other sources of carbohydrates such as grain, potato, corn and rice. Also, the gas injected into the must in the tank 14 is air, but other gasses, such as nitrogen, oxygen and carbon dioxide may be injected into the must.

In this and other embodiments, the system 10 includes five injectors 12, each of which the controller 16 may control (open and close) independently of the other four injectors 12. This allows one to use the system 10 to drain must from one, two, three, four, or five tanks 14. This also allows one to use one, two, three, four, or five injectors 12 (as shown in FIGS. 2A and 2B) in a single tank 14 to generate a bubble at more than one location within the tank 14. The injectors 12 may be any injector desired capable of injecting gas, and may be located inside the tank 14 or outside the tank 14. For example, in this and other embodiments, the injectors 12 may be any conventional injector and located outside the tank 14. Consequently, the conduit 20 includes five separate conduits 20, each coupling a respective one of the five injectors 12 to the inside of the tank 14. To prevent the juice of the fermenting must inside the tank 14 from entering the conduits 20, the system 10 includes one or more check valves (shown in FIG. 2A). When the injectors 12 are open to inject gas into the conduit 20, the check valves allow the gas to enter the tank 14. When the injectors 12 are closed, the check valves prevent the juice from entering the conduit 20. By locating the injectors 12 outside the tank 14, one my easily repair or maintain the injectors 12 without having to drain the tank 14. Thus, one can continue to ferment juice in the tank 14 while working on an injector 12. And, one can use the injectors 12 to drain fermenting must from another, separate tank (not shown) by simply uncoupling the conduit 20 from the tank 14, moving the system 10 close to the other tank 14, and then coupling the conduit 20 to the tank 14.

Other embodiments are possible. For example, the injectors 12 may be located inside the tank 14 and may be as shown and discussed in U.S. Pat. No. 6,629,773 titled Method And Apparatus For Gas Induced Mixing And Blending Of Fluids And Other Materials issued to Mr. Parks on 7 Oct. 2003, which is incorporated herein by this reference.

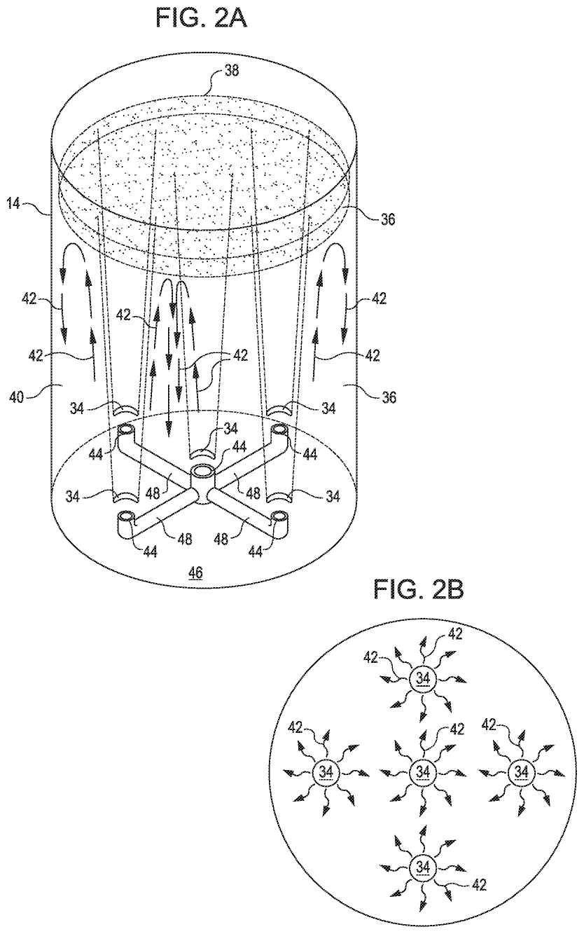

Still referring to FIG. 1, the system 10 also includes a draining protocol that the controller 16 follows to direct the opening and closing of the injectors 12. As discussed in greater detail in conjunction with the FIGS. 2A, 2B and 3, the draining protocol includes instructions for generating a single bubble or multiple bubbles, within two, separate periods—a break-cap period and a mix period. In this and other embodiments, the draining protocol includes instructions for generating a series of bubbles during the break-cap period, and other instructions for generating another series of bubbles during the mix period. More specifically, the draining protocol starts the mix period immediately after the end of the break-cap period, and each of the bubbles generated during the break-cap period includes more gas, and thus are larger, than each of the bubbles generated during the mix period.

To convey the instructions from the controller 16 to each of the injectors 12, the system 10 includes a conduit 22. In this and other embodiments, the conduit 22 may be piping that conveys a fluid, which may be gas that is the same as the gas in the bubbles, between the controller and the injectors 22. Moreover, the controller 16 includes a control circuit (not shown), as discussed in U.S. patent application Ser. No. 16/024,483 titled Control Circuit For Stopping The Flow Of A Fluid In A Primary Circuit, and Related Methods and Devices filed 29 Jun. 2018, which is herein incorporated by this reference, to monitor the flow of gas through the injectors 12 and adjust the flow in response to the presence of a characteristic of the monitored flow. In other embodiments, the conduit 22 may be wiring that conveys electric current between the controller and the injectors 22.

The system 10 also includes a source of gas 24, and a distribution line 26 to supply the injectors 12 with the gas. The system 10 may also include additional components. For example, in this and other embodiments, the system 10 includes a pressure regulator 28 to allow one to adjust the pressure of the gas injected by the injectors 12, and thus the volume of gas injected for a given injection time (discussed in greater detail in conjunction with FIGS. 2A, 2B and 3). The system 10 may also include a filter 30 to prevent dust or other materials and/or chemicals in the gas from damaging the injectors 12.

In addition, the system 10 may include an accumulator plate (not shown) to help form one or more bubbles in the tank 14 as discussed in U.S. Pat. Nos. 6,629,773 and 4,595,296 titled Method and Apparatus for Gas Induced Mixing and Blending issued to Mr. Parks on 17 Jun. 1986, which is herein incorporated by this reference. The accumulator plate allows the gas injected during an injection interval to combine to form a large bubble, which then moves through the must. A larger bubble may be desired to provide the desired flow characteristics in the must. For example, as the bubble's size increases, the bubble's rate of travel through the must decreases, and the amount of juice that the bubble urges to flow increases. When the accumulator plate is located near the check valves, the gas injected through the check valves can form a large bubble before moving through the must.

Each of FIGS. 2A and 2B shows bubbles 34 generated by the system 10 shown in FIG. 1 moving through must 36 in a tank 14 to break a cap 38 formed in the must 36, each according to an embodiment of the invention. More specifically, FIG. 2A is a perspective view of a tank 12 holding the juice 40 and cap 38 of the must 36, and shows the bubbles 34 moving through the juice 40 toward the cap 38, and the flows (shown as arrows, thirteen of which are labeled as 42 for reference) of the juice 40 that the bubbles 34 generate. FIG. 2B is a plan view of the tank 14 in FIG. 2A showing the flows 42 of juice 40 underneath the cap 38.

As previously discussed herein and discussed in greater detail in U.S. Pat. Nos. 6,629,773 and 4,595,296, the movement of the one or more bubbles 34 through the fermenting juice 40 urges portions of the juice 40 to flow within the tank 14. These flows 42 of juice 40 can be used to break the cap 38 formed during fermentation and reduce the size of the subsequent portions of the cap 38 or cap chunks (not shown). The characteristics of these flows 42 determine the manner in which the cap 38 is broken into cap chunks; and largely depend on the spatial and temporal relationships between each bubble 34 generated by the system 10.

The spatial relationship between each bubble 34 can be any desired relationship to promote breaking the cap 38. For example, in one embodiment, the check valves 44 may be located at or near the bottom 46 of the tank 14 in a pattern resembling an “x”. If each check valve 44 releases gas into the fermenting juice 40 at substantially the same time, the flows 42 of juice 40 generated by the bubbles 34 moving toward the cap 38 substantially circulate in four circulation zones. As shown in FIG. 2A, when the flows 42 in each circulation zone contact the cap 38 the flows 42 turn and move substantially parallel to the cap 38. Because the tank 14 prevents the cap 38 from moving with the flows 42, and the flows 42 move in different directions relative to the cap 38, the flows 42 generate shear across portions of the cap's bottom surface. At these portions of the cap's bottom surface, this shear tends to erode the cap 38 and generate cracks through the cap 38 to break the cap 38 into chunks. Then, to help break the cap 38, each bubble 34 exerts pressure on the cap 38 when the bubble 34 reaches the cap 38. Thus, the combination of the shear generated by the flows 42 of fermenting juice 40 and the pressure exerted by the bubbles 34 when they reach the cap 38 breaks the cap 38 into chunks whose size largely depends on the spatial relationship of the bubbles 34.

Other embodiments are contemplated. For example, the check valves 44 may be located away from the bottom 46, and thus closer to the cap 38, and form a pattern resembling substantially concentric rings. In another example the number of check valves 44 located in a tank 14 may be more or less than five. In yet another example, the check valves 44 and line sections 48 may move in the tank 14, for example rotate relative to the tank's bottom 46, as gas is injected into the fermenting juice 40.

Still referring to FIGS. 2A and 2B, the temporal relationships between each bubble 34 (discussed in greater detail in conjunction with FIG. 3) includes the interval between forming successive bubbles 34 from the same check valve 44 to form a series of bubbles 34, and the interval between forming a bubble 34 from one check valve 44 to forming another bubble 34 from another check valve 44. In addition, a series of bubbles 34 may be temporally organized into one or more bubble pulses, in which a single pulse of bubbles 34 includes a series of bubbles 34, each having the same interval between them. When two or more bubble pulses are generated, the interval between two of the bubbles 34 is not the same as the interval between the bubbles 34 that comprise one or more of the individual bubble pulses. For example, a first bubble pulse may include a series of three bubbles 34, each having an interval of two seconds between them, followed by an interval of ten seconds between the third bubble 34 of the first pulse and the first bubble of the next pulse, which includes a series of five bubbles 34 each having an interval of five seconds between them.

FIG. 3 shows a schematic diagram of an operation of the system 10 shown in FIG. 1 to generate a series of bubbles 34 (FIGS. 2A and 2B) by following a draining protocol, according to an embodiment of the invention. The schematic diagram shows the temporal relationship of a series of bubbles 34 generated from a single injector 12. As previously discussed in conjunction with FIGS. 2A and 2B, the draining protocol may involve the operation of two or more injectors, simultaneously and/or sequentially.

In this and other embodiments the draining protocol includes a break-cap period 52 and a mix period 54. During the break-cap period 52 bubbles are generated in the must to break the cap in the upper portion of the must. After the cap has been broken into chunks, the mix period 54 begins during which bubbles are generated in the must to homogenize the must and reduce the size of the cap chunks to a size that can pass through the drain (18 in FIG. 1) of the tank holding the fermenting must. The break-cap period 52 may begin at any desired moment during the fermentation of the must, and may last as long as desired. Likewise, the mix period 54 may begin at any desired moment during the must's fermentation after the break-cap period 52 ends, and may last as long as desired. For example, in this and other embodiments, the break-cap period 52 begins about ten minutes before the must is to be removed from the fermentation tank, and lasts for eight minutes. Then, immediately following the break-cap period 52, the mix period 54 begins and lasts until most, if not all, of the must is drained from the fermentation tank. Specifically, the mix period 54 proceeds while the must drains from the tank and stops when the check valves located inside the tank are no longer submerged. Here the mix period 54 lasts for about seven minutes.

Other embodiments are contemplated. For example, the break-cap period 52 may last longer than or shorter than ten minutes depending on the extent of the cap's breakage one desires. For another example, the mix period 54 may last longer or shorter than seven minutes. For another example, the mix period 54 may begin after a delay at the end of the break-cap period 52. For yet another example, the draining protocol may include two or more break-cap periods 52, and/or two or more mix periods 54.

To form a pulse of bubbles from an injector (12 in FIG. 1), the controller (16 in FIG. 1) opens the injector 12 for a period of time; closes the injector for another period of time and then re-opens the injector 14. Each period of time that the injector 14 is open is an injection period 56, each period of time that the injector 12 is closed is an interval 58, and each time in the break-cap and mix periods 52 and 54 that the injector 12 opens is a moment 60.

The break-cap period 52 may include any desired number of bubbles having any desired size. For example, in this and other embodiments the break-cap period 52 includes a series of bubbles that forms a single bubble pulse. Each bubble is started at the moment 60a and has an injection period 56a of one second. The interval 58a between successive bubbles is five seconds. To increase the shear on the cap (38 in FIG. 2A) caused by juice flowing in the tank and to increase the pressure each bubble exerts on the cap when the bubble reaches the cap, the injection period 56a may be increased and/or the interval 58a may be decreased. Also, adjusting the pressure regulator 28 (FIG. 1) to increase the pressure of the gas injected into the must increases the shear and pressure exerted on the cap by increasing the size of the bubble for a given injection period 58a. Thus, the system 10 can be used to efficiently break different sized caps, and drain must having different viscosities.

Likewise, the mix period 54 may include any desired number of bubbles having any desired size. For example, in this and other embodiments the mix period 52 includes a series of bubbles that forms a single bubble pulse. Each bubble is started at the moment 60b and has an injection period 56b of 0.5 seconds. The interval 58b between successive bubbles is ten seconds. Thus, the amount of gas injected into the must at each moment 60a during the break-cap period 52 is greater than the amount of gas injected into the must at each moment 60b during the mix period 54, which means that larger bubbles are formed during the injection periods 56a during the break-cap period 52 than during the injection periods 56b during the mix period 54. To increase the mixing action during the mix period 54, and thus increase the homogenizing and size-reduction affects, the injection period 56b may be increased and/or the interval 58b may be decreased. Also, adjusting the pressure regulator 28 to increase the pressure of the gas injected into the must increases the homogenizing and size-reducing affects of the flow of must within the tank by increasing the size of the bubble for a given injection period 58b.

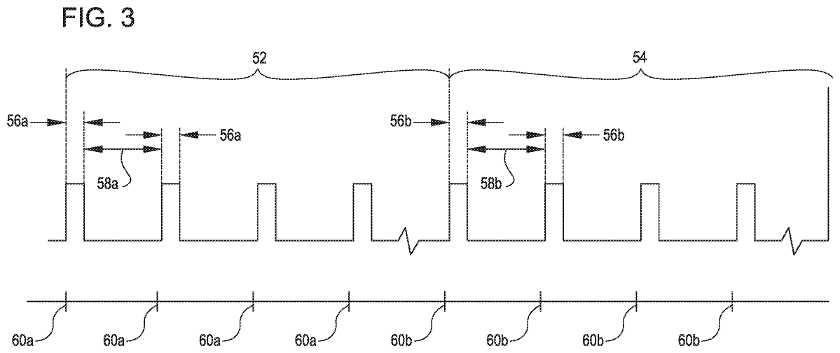

FIG. 4 shows a schematic diagram of a controller 16 that the system 10 shown in FIG. 1 incorporates, according to an embodiment of the invention.

In this and other embodiments, the controller 16 includes computer circuitry 66, which includes a processor 68 and a memory 70 coupled to the processor 68, for executing software, which includes one or more draining protocols, to perform desired calculations, and to open and close the injectors (12 in FIG. 1). As the circuitry 66 executes software, the memory 70 stores some or all of the instructions and data included in the draining protocol, and the processor 68 retrieves the instructions and data, and opens and closes the injectors 12 accordingly. The controller 16 also includes one or more input devices 72 that are coupled to the computer circuitry 66 and allow one to input data thereto, and one or more output devices 74 that are coupled to the circuitry 66 to provide one data generated by the circuitry 66. The controller 16 also includes an output module 76 to generate a signal that opens or closes the injectors 12, and a communication device 78 to allow one to retrieve data generated by the circuitry 66 or input data to the circuitry 66 over a communications network (not shown). With the controller 16 executing one or more draining protocols, the system (10 in FIG. 1) can automatically break the cap (38 in FIG. 2A) and drain the must from two different tanks fermenting two different musts without having to program the controller in between. Also, one can modify the draining protocol associated with a specific must during the fermentation process to allow one to respond to the actual progress of the fermentation process.

The input device 72, output device 74, and communication device 78 may be any desired devices capable of performing their desired function. For example, in one embodiment, the input device 72 includes a touch screen having regions that one can touch to input data into the computer circuitry 66 and may also include a keyboard, mouse or microphone. The output device 74 also includes the touch screen and may also include a printer. The communication device 78 includes a modem, which may or may not be wireless, to receive and transmit data to and from the computer circuitry 66 over a communication network such as an intranet or the internet.

Still referring to FIG. 4, the draining protocols include data and instructions that the processor 68 processes to open and close the injectors 12 to generate bubbles in the break-cap and mix periods. The data and instructions include information about the injection time (56 in FIG. 3), interval (58 in FIG. 3), and moment (60 in FIG. 3) for each injector 14 during the draining protocol, and the time that the draining protocol commences. For example, in one embodiment, a draining protocol may include a single break-period (52 in FIG. 3), a single mix period (54 in FIG. 3), and may commence ten minutes before the must is to be drained from the fermentation tank, as discussed in conjunction with FIG. 3. Another draining protocol may include two break-cap periods followed by a single mix period with a delay of ten minutes between the last break-cap period and the mix period. This draining protocol may commence thirty minutes before the must is to be drained from the fermentation tank. The first break-cap period may include an injection time of 1.5 seconds for each bubble generated, and an interval of ten seconds. The second break-cap period may include an injection time of 0.5 seconds for each bubble generated, and an interval of five seconds. And the mix period may include an injection time of 0.3 seconds for each bubble generated, and an interval of five seconds.

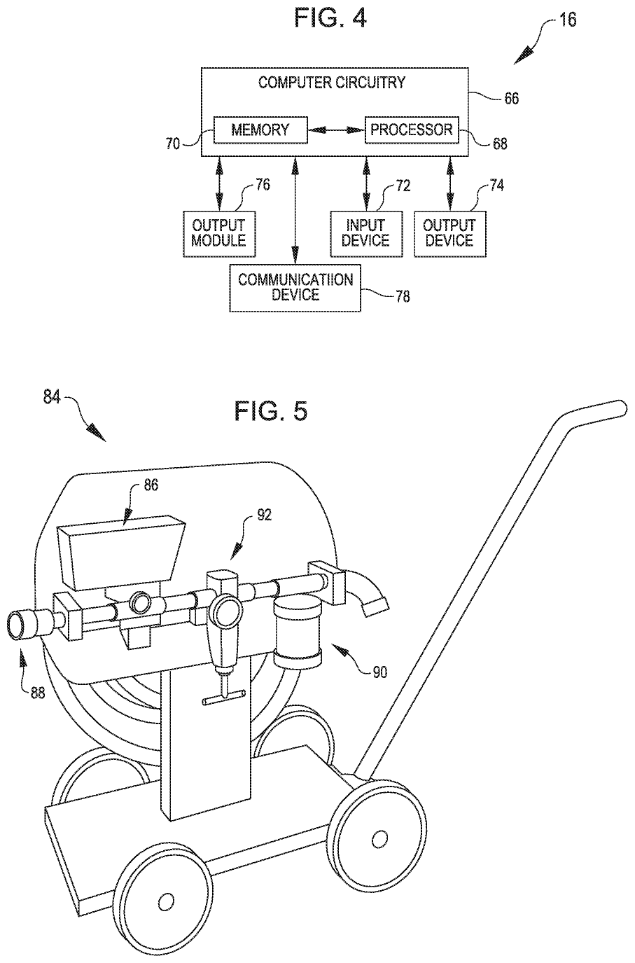

FIG. 5 shows a perspective view of a system 84 for draining fermenting must from a tank, according to another embodiment of the invention. The system 84 is similar to the system 10 shown in FIGS. 1-4 except that the system 84 includes a single injector 86 that may coupled to a rigid pipe (not shown) via the coupler 88. The other end of the rigid pipe may then be inserted into a tank via a port (not shown) or via an open top of the tank much like a straw in a glass of soda. In this manner, the system 84 may be used to drain fermenting must from a tank that only has a drain like many, small fermentation tanks. The system 84 also includes a filter 90, and a pressure regulator 92.

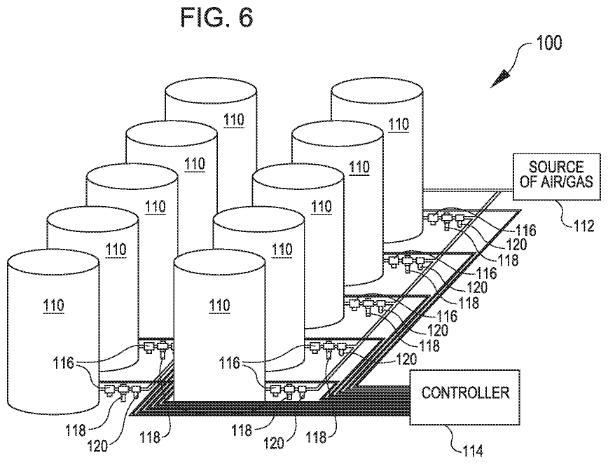

FIG. 6 shows a perspective view of a system 100 for draining fermenting must from a group of tanks, according to another embodiment of the invention. The system 100 is similar to the system 10 except that the system 100 performs a draining protocol in each of the ten tanks 110 to drain the must in each tank 110. The system 110 includes a source of gas 112, a controller 114, injectors 116, pressure regulators 118, and filters 120. Another difference between the system 100 and the system 10 is that distribution of gas to the one or more check valves inside the tank 110 is made through the side of the tank 110, not through the bottom of the tank 110. Other embodiments are possible. For example, the system 110 (and/or the system 10) may be configured such that distribution of gas to the one or more check valves (and/or injectors) inside the tank 110 (and/or the tank 14) is made through the top of the tank 110 (and/or tank 14).

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A method for draining fermenting must from a fermentation tank, the method comprising:
breaking a cap that forms in a fermentation tank while must ferments in the tank, wherein breaking the cap includes:
injecting gas into the must to form a bubble in the must,
moving the bubble through the must to generate a flow of must within the fermentation tank, and
shearing a surface of the cap with the generated flow to break the cap into chunks;
after breaking the cap, mixing the must to homogenize the must and reduce the size of the cap chunks to a size can pass through a drain of the tank, wherein mixing the must includes:
injecting gas into the must to form a bubble in the must, and
moving the bubble through the must to mix the must; and
opening the drain in the fermentation tank to remove the must from the tank.

2. The method of claim 1, wherein the bubble formed to break the cap includes a volume of gas, and the bubble formed to mix the must includes the same volume of gas.

3. The method of claim 1 wherein the bubble formed to break the cap includes a volume of gas, and the bubble formed to mix the must includes a volume of gas that is less than the volume of gas in the bubble formed to break the cap.

4. The method of claim 1 wherein injecting gas into the must to break a cap that forms during fermentation includes injecting gas into the must at a plurality of moments during a break-cap period, each moment occurring at the beginning of a respective one of a plurality of intervals within the break-cap period, to generate a series of bubbles, each of which moves through the must to generate a flow of must within the fermentation tank.

5. The method of claim 4 wherein the amount of gas injected into the must at each of the plurality of moments during the break-cap period is the same.

6. The method of claim 4 wherein the duration of each of the plurality of intervals is the same.

7. The method of claim 1 wherein injecting gas into the must to mix the must to homogenize the must and reduce the size of the cap chunks includes injecting gas into the must at a plurality of moments during a mix period, each moment occurring at the beginning of a respective one of a plurality of intervals within the mix period, to generate a series of bubbles, each of which moves through the must to mix the must.

8. The method of claim 7 wherein the amount of gas injected into the must at each of the plurality of moments during the mix period is the same.

9. The method of claim 7 wherein the duration of each of the plurality of intervals is the same.

10. The method of claim 1 wherein:
injecting gas into the must to break a cap that forms during fermentation includes injecting gas into the must at a plurality of moments during a break-cap period, each moment occurring at the beginning of a respective one of a plurality of intervals within the break-cap period, to generate a series of bubbles, each of which moves through the must to generate a flow of must within the fermentation tank;
injecting gas into the must to mix the must to homogenize and reduce the size of the cap chunks includes injecting gas into the must at a plurality of moments during a mix period, each moment occurring at the beginning of a respective one of a plurality of intervals within the mix period, to generate a series of bubbles each of which moves through the must to mix the must; and
the duration of the break-cap period exceeds the duration of the mix period.

11. The method of claim 10 wherein the duration of each of the plurality of intervals during the break-cap period is less than the duration of each of the plurality of intervals during the mix period.

12. The method of claim 11 wherein the amount of gas injected into the must at each of the plurality of moments during the break-cap period exceeds the amount of gas injected into the must at each of the plurality of moments during the mix period.

13. The method of claim 11 wherein injecting gas into the must to mix the must to homogenize and reduce the size of the cap chunks occurs immediately after the last interval during the break-cap period ends.

14. The method of claim 1 wherein opening the drain in the fermentation tank includes opening the drain while injecting gas into the must to mix the must to homogenize and reduce the size of the cap chunks.

15. A system for draining fermenting must from a fermentation tank, the system comprising:
a drain operable to allow fermenting must to flow out of a fermentation tank;
an injector operable to inject gas into the fermenting must held in the fermentation tank to form a bubble operable to break a cap formed in the must, and to mix the must;
a source of gas to supply the injector; and
a controller operable to open and close the injector and including:
a memory operable to store a draining protocol that includes instructions for opening and closing the injector during a break-cap period and during a mix period that follows the break-cap period, and
a processor operable to retrieve the draining protocol from the memory, and open and close the injector according to the draining protocol's instructions during the break-cap period and during the mix period.

16. The system of claim 15 wherein the system includes two or more injectors each operable to inject gas into the fermenting must, and the controller is operable to open and close each injector.

17. The system of claim 15 wherein:
the injector is located outside the fermentation tank, and
the system further comprises a check valve coupled with the injector and operable to release gas from the injector into the tank and prevent the ingredients from entering the injector.

18. The system of claim 15 further comprising a pressure regulator operable to control the gas pressure supplied to the injector.

19. The system of claim 15 wherein the controller includes a display operable to show the processor's progress through the draining protocol, and to allow one to provide the controller data to modify the draining protocol.
